(19) United States
(12) Patent Application Publication
(10) Pub. No.: US 2009/0265726 A1
(43) Pub. Date: Oct. 22, 2009

(54) OPTICAL DISC DRIVE AND ELECTRONIC APPARATUS

(75) Inventors: Takayuki FUJIMOTO, Tsuchiura (JP); Makoto IBE, Hitachinaka (JP); Seiji HAMAIE, Kawasaki (JP); Nozomu HARADA, Kawasaki (JP); Shinya ASANO, Tokyo (JP); Yoshiaki YAMAUCHI, Omitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi, Ltd.; Hitachi-LG Data Storage, Inc.

(21) Appl. No.: 12/427,889

(22) Filed: Apr. 22, 2009

(30) Foreign Application Priority Data
Apr. 22, 2008 (JP) 2008-110949

(51) Int. Cl. G11B 17/04

(52) U.S. Cl. 720/601; G9B/17.013

(57) ABSTRACT

An optical disc drive comprises: a disc tray 3, which is configured to be used for loading/ejecting of a disc 2 as information recording medium; an optical pickup member 7, which has a laser element 8a for oscillating a laser light therefrom, to be irradiated on the disc 2; a disc rotating mechanism, which is configured to rotate the disc 2; a transferring mechanism, which is configured to move the optical pickup member 7 between an inner periphery portion and an outer periphery portion of the disc 2; and a decorative laminated board 10, which is provided between the disc 2 loaded and a controller portion mounted, wherein the decorative laminated board 10 has a wind guidance opening 21, for guiding an air into an area facing to the laser element 8a of the optical pickup member 7 when the optical pickup member has moved to the outermost periphery portion of the disc 2 to be rotated, and the disc tray 3 has a wind guidance wall 22 on a surface thereof, facing to the optical pickup member 7 having moved to an outermost periphery portion of the disc 2, extending from the wind guidance opening 21 or vicinity thereof into a reversed rotation direction of the disc 2.

### BACKGROUND OF THE INVENTION

The present invention relates to an optical disc drive for recording/reproducing data while rotating a disc, i.e., information recording medium, and an electronic apparatus.

An optical disc drive or apparatus is a data memorizing apparatus, for recoding data onto a disc surface or reproducing data recorded on the disc surface, under the condition of rotating the disc, i.e., the information recording medium.

In this optical disc drive, an electronic part (i.e., an optical head) having a semiconductor laser element, a laser receiving portion, etc., to be used as a signal writing means for recording data and as a signal readout means for reproducing data, is called “an optical pickup” or simply “a pickup”.

Also, as the discs, i.e., the data recording media can be listed the followings: for example, CD-ROM (Compact Disk Read Only Memory), CD-R (Compact Disk Recordable), CD-RW (Compact Disk ReWritable), DVD-ROM (Digital Versatile Disk Read Only Memory), DVD-R (Digital Versatile Disk Recordable: a postscript type DVD allowing writing only one (1) time), DVD-RW (one (1) of standards for rewritable type DVD), DVD-RAM (Digital Versatile Disk Random Access Memory), DVD+R (standard for the postscript type DVD), DVD+RW (one (1) of standards for rewritable type DVD), BD-ROM (Blu-ray (Registered trade mark) Disc Read Only Memory), BD-R (Registered trade mark) Disc Recordable), and BD-RE (Registered trade mark) Disc Rewritable), etc.

In general, the optical disc drive is mounted in an electronic apparatus, such as, a personal computer, etc., having a central processing unit (CPU) for executing access controls to the optical disc drive, and also calculating processes, etc. In general, the optical disc drive is called “half-height” type optical disc drive, if the electronic apparatus, into which it is to be mounted, is a desk-top type personal computer; on the other hand, it is called “slim” type optical disc, in general, if it is to be mounted in a notebook-type personal computer (a portable personal computer). Further, this half height means the thickness of the built-in drive is about 1.6 inches (=4.1 cm).

At the present, it is required to increase the data memory capacity to be much larger, for the optical disc drive.

Then, it is necessary to multiply the disc recording layer, but for enabling the multilayer recording, it is necessary to increase an optical output of the semiconductor laser higher than that for a single layer recording. As a result thereof, it brings about an abrupt increase of temperature of the semiconductor, and this reduces the lifetime of the element, and further, makes the following problem remarkable; i.e., lowering the quality of the optical disc drive due to deterioration of each of constituent elements.

In particular, in case of the slim type optical disc drive, since it is smaller in volume of the housing thereof than that of the half-height type optical disc drive, i.e., high-density mounting; therefore, the laser element is exposed in a temperature atmosphere higher than that of the half-height type optical disc drive. Also, since the temperature of the laser element shows the maximum when the optical pickup moves to the outermost peripheral position of the disc, because of a long time-time operation of the laser element, and/or a fact that the heat generated by the laser element stays at the outermost peripheral position due to an airflow generated by rotation of the disc, etc., then it is necessary to radiate the heat, effectively, which is generated by the laser element at this time.

As a countermeasure of this, in the following Patent Documents 1 and 2, for example, there is proposed a method for brining the optical pickup to radiate the heat, by means of an airflow passing through a ventilation opening, which is generated by circulation of the air accompanying with the rotation of the disc, while providing the ventilation opening on a supporting plate for the optical pickup, i.e., a decorative laminated board, in the vicinity of the outermost periphery of the disc.

[Patent Document 1] Japanese Patent Laying-Open No. Hei 11-25667 (1999), (in particular, see columns 0012-0014, and FIGS. 1 and 2, etc.); and

[Patent Document 2] Japanese Patent Laying-Open No. 2005-100561, (in particular, see column 0043, and FIGS. 2, 6 and 8, etc.).

### BRIEF SUMMARY OF THE INVENTION

By the way, the position for attaching the laser element in the optical disc drive differs from, depending on each of the optical pickups, and further, in the multilayer recording mentioned above, it is impossible to increase the rotation speed of the disc, greatly, as can be in the single layer recording. Accordingly, only with provision of the ventilation opening on the decorative laminated board, as is disclosed in the Patent Documents 1 and 2, promotion of heat radiation cannot be achieved for the laser element, only by increasing the velocity of the airflow, locally, surrounding the laser element; therefore, it is impossible to dissolve the problem of lowering the quality due to generation of the heat.

Then, for the purpose of promoting the heat radiation of the laser element, each being attached at the different position for each optical pickup, a new structure is necessary for introducing the airflow generated by rotation of the disc, locally, up to the periphery of the laser element, when the laser element is moved to the outermost peripheral position of the disc where the temperature of the laser element shows the maximum value thereof.

In particular, in the multilayer recording where the rotation speed of the disc cannot be increased greatly, as well as, the output of the laser beams must be higher than that of the single layer recording, there is further necessity of a new structure for increasing the velocity of the airflow in the periphery of this laser element.

In this manner, in the optical disc drive, there is a technical problem to be dissolved that the lifetime of the laser element is shortened or lowered due to the increase of temperature of the laser element, and that performances of capacities of the optical disc drive are deteriorated.

An object according to the present invention, accomplished by taking the situations or drawbacks mentioned above into the consideration thereof, is to provide an optical disc drive and an electronic apparatus, for enabling to protect the laser element from deterioration of such performances or capacities thereof, such as, shortening or lowering of the lifetime of the laser element accompanying with an increase of temperature thereof, etc.

For accomplishing the object mentioned above, according to the present invention, firstly there is provided an optical disc drive, comprising: a disc tray member, which is configured to be used for loading/ejecting of a disc as information recording medium; an optical pickup member, which has a laser element for oscillating a laser light therefrom, to be irradiated on said disc; a disc rotating mechanism, which is configured to rotate said disc; a transferring mechanism, which is configured to move said optical pickup member between an inner periphery portion and an outer periphery portion of said disc; and a decorative laminated board, which is provided between said disc loaded and a controller portion mounted, wherein said decorative laminated board has a wind guidance opening, for guiding an air into an area facing to the laser element of said optical pickup member when said optical pickup member has moved to the outermost periphery portion of said disc to be rotated, and said disc tray member has a wind guidance wall portion on a surface thereof, facing to said optical pickup member having moved to an outermost periphery portion of said disc, extending from said wind guidance opening or vicinity thereof into a reversed rotation direction of said disc.

Further, according to the present invention, secondary, there is provided an electronic apparatus, having therein an optical disc drive, comprising: a disc tray member, which is configured to be used for loading/ejecting of a disc as information recording medium; an optical pickup member, which has a laser element for oscillating a laser light therefrom, to be irradiated on said disc; a disc rotating mechanism, which is configured to rotate said disc; a transferring mechanism, which is configured to move said optical pickup member between an inner periphery portion and an outer periphery portion of said disc; and a decorative laminated board, which is provided between said disc loaded and a controller portion mounted, wherein said decorative laminated board has a wind guidance opening, for guiding an air into an area facing to the laser element of said optical pickup member when said optical pickup member has moved to the outermost periphery portion of said disc to be rotated, and said disc tray member has a wind guidance wall portion on a surface thereof, facing to said optical pickup member having moved to an outermost periphery portion of said disc, extending from said wind guidance opening or vicinity thereof into a reversed rotation direction of said disc.

With to the optical disc drive according to the present invention, it is possible to achieve an optical disc drive and an electronic apparatus for enabling to protect the laser element from the deterioration of performances or capacities thereof, such as, shortening or lowering of the lifetime of the laser element accompanying with the increase of temperature thereof, etc.

### BRIEF DESCRIPTION OF THE DRAWINGS

Those and other objects, features and advantages of the present invention will become more readily apparent from the following detailed description when taken in conjunction with the accompanying drawings wherein:

FIG. 1A is a plane view including a partial cutoff portion thereof, for showing an outline of the internal structures of an optical disc drive, according to a first embodiment of the present invention; and FIG. 1B is an enlarged cross-section view of the optical disc drive shown in FIG. 1A, being cut along an A-A line, under the condition attaching a decorative laminated board on the surface side thereof;

FIG. 2 is a plane view for showing the outline structures of a mechanical chassis in the optical disc drive according to the first embodiment, under the condition of detaching a disc tray and the decorative laminated board thereof;

FIG. 3 is a plane view for showing the decorative laminated board within the optical disc drive according to the first embodiment;

FIG. 4A is a plane view for showing the disc tray from a surface side thereof, under the condition of detaching a bottom plate cover in FIG. 1A; FIG. 4B is a plane view of a single body of the disc tray, seen from the reverse side surface thereof; and FIG. 4C is an enlarged perspective view for showing the vicinity of a wind guidance wall formed on the reverse surface of the disc tray shown in FIG. 4B, seen from the direction “B”;

FIG. 5 is an enlarged cross-section view of the wind guidance wall and the decorative laminated board shown in FIG. 4A, being cut along a C-C line;

FIGS. 6A through 6D are enlarged cross-section views for showing other examples of the wind guidance wall and the decorative laminated board shown in FIG. 4A, being cut along the C-C line;

FIG. 7 is a plane view for showing an outline structure of an inside of the optical disc drive, according to the first embodiment, while showing an air flow flowing along with the wind guidance wall of the disc tray up to a wind guidance opening by arrows;

FIG. 8 is a perspective view for showing an outline structure of the inside of the optical disc drive, according to the first embodiment, while showing an air flowing in the vicinity of the laser element passing through the wind guidance opening, after flowing along with the wind guidance wall of the disc tray up to the wind guidance opening;

FIG. 9 is a graph for showing a heat radiation promotion effect according to the first embodiment;

FIG. 10 is a plane view for showing the structures of the decorative laminated board of the optical disc drive, according a variation of the first embodiment;

FIG. 11A is a plane view including a partial cutoff portion thereof, for showing an outline of the internal structures of an optical disc drive, according to the variation of the first embodiment; and FIG. 11B is a plane view for showing the reverse surface of a single body of the disc tray in the optical disc drive, according to the variation of the first embodiment;

FIG. 12A is a plane view of the decorative laminated board of the optical disc drive according to a second embodiment; and FIG. 12B is an enlarged cross-section view of the decorative laminated board, being cut along the D-D line, when adding the disc tray thereto;

FIGS. 13A through 13D are enlarged cross-section views of the decorative laminated board, being cut along the D-D line, when adding the disc tray thereto;

FIG. 14 is a plane view of the decorative laminated board when altering the position for attaching the laser element in the optical disc drive, according to a variation of the second embodiment;

FIG. 15 is an enlarged cross-section view of the disc tray shown in FIG. 4A, being cut along the C-C line, but according to a third embodiment;

FIG. 16 is a plane view for showing around the disc tray 3, according to a fourth embodiment, including a cutoff portion thereof;

FIG. 17A is a plane view for showing around the disc tray 3, according to a fifth embodiment; and FIG. 17B is an enlarged cross-section view thereof, being cut along an E-E line, while showing an airflow therein by an arrow; and

FIG. 18A is a cross-section view for showing the structures with putting or inserting a sponge-like member between the wind guidance wall, which is provided on the disc tray, and the decorative laminated board; and FIG. 18B is a cross-section view for showing the structures with putting or inserting the sponge-like member between the wind guidance wall, which is provided on the decorative laminated board, and the disc tray.

### DETAILED DESCRIPTION OF THE PREFERRED EMBODIMENT(S)

Hereinafter, embodiments according to the present invention will be fully explained by referring to the attached drawings.

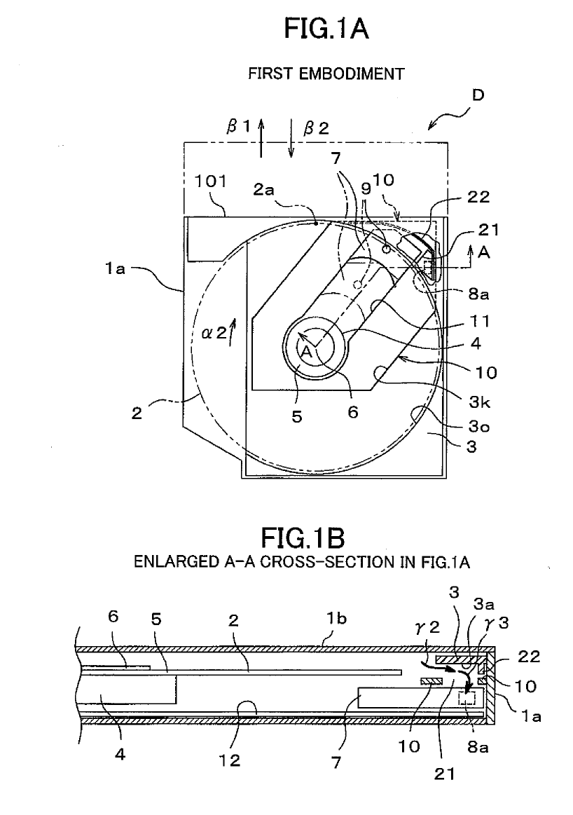

FIG. 1A is a plane view for showing an outline of the internal structures of an optical disc drive or apparatus D, according to a first embodiment of the present invention. In this FIG. 1A, the optical disc drive is shown, but eliminating a top plate cover 1b therefrom (see FIG. 1B), and also a disc 2 is shown by two-dotted lines. FIG. 1B is an enlarged cross-section view of the optical disc drive D shown in FIG. 1A, being cut along an A-A line, under the condition of attaching the top plate cover 1b on a surface side thereof, and in this figure is shown the disc 2 by solid lines.

### Outline of Optical Disc Drive D of Present Embodiment

An embodiment of the present invention will be shown, as an example, in particular, when applying the present invention into a slim type optical disc drive (hereinafter, being called “an optical disc drive”).

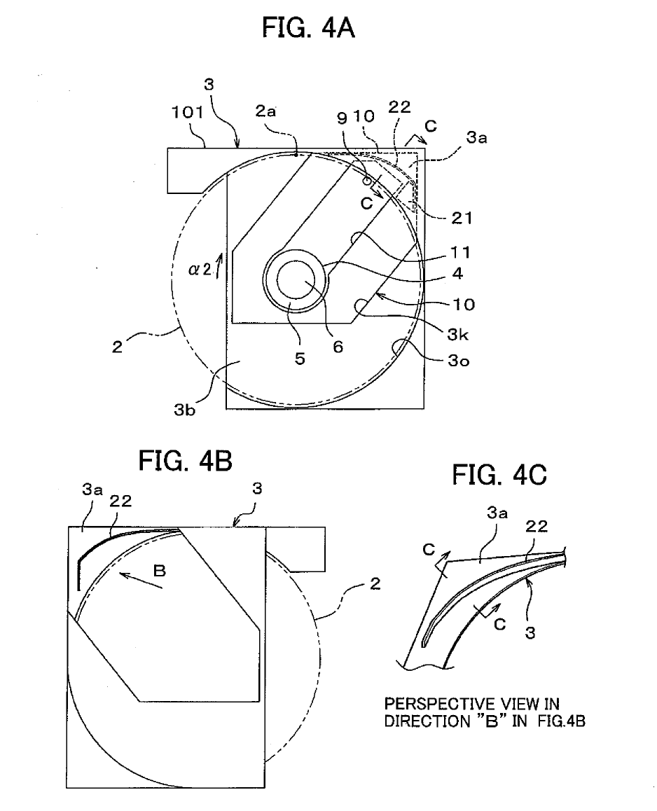

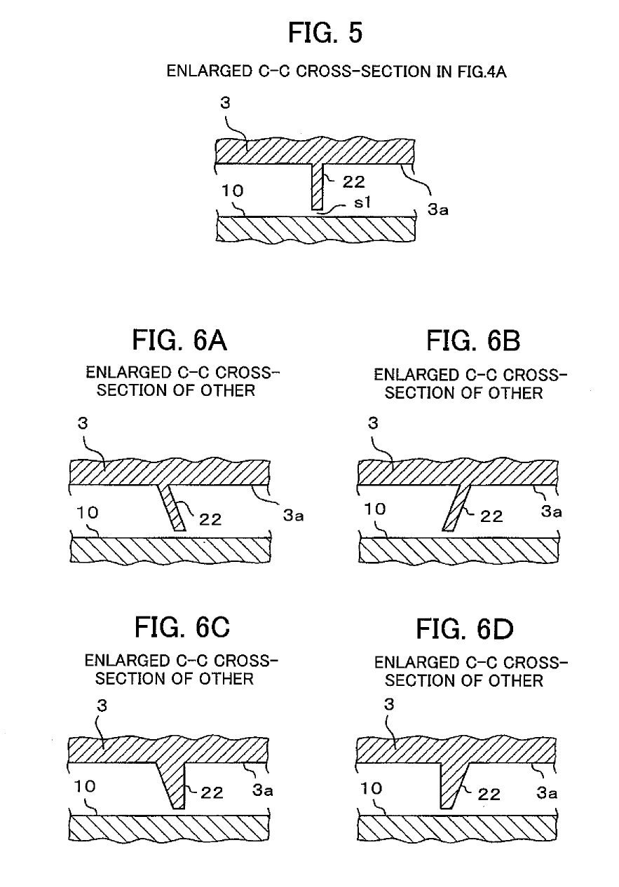

In the optical disc drive D, according to the present embodiment, while paying an attention onto the fact that a laser element 8a goes up to high temperature when it reaches to the outermost peripheral portion of the disc 2 upon conducting recoding/reproducing with using the laser element 8a, a wind guidance opening 21 is drilled for guiding an airflow due to rotation of the disc 2 to an area or region of a decorative laminated board 10 facing to the laser element 8a, which has moved to the outermost peripheral portion of the disc 2, and also is provided a wind guidance wall 22 (10b) along with a smooth line, extending from an imaginary contact point 2a (see FIG. 4A) contacting with an outer periphery of the disc 2 to a place following the wind guidance opening 21 on the decorative laminated board 10, in the direction same to the rotating direction of the disc 2 (i.e., direction of an arrow “α2” in FIG. 1A).

However, with this wind guidance wall 22, a certain effect of guiding a wind can be obtained by providing the wall extending from the wind guidance opening 21 on the decorative laminated board 10 or the vicinity thereof in the reverse direction of rotation of the disc 2.

With this, an airflow produced due to rotation of the disc 2 when recording/reproducing, flowing into the clockwise direction gradually, as it moves from a central portion of the disc 2 to the outermost periphery, blows or puffs directing to the laser element 8a, which has moved to the outermost peripheral portion of the disc 2, through the wind guidance opening 21, after being bounded on the wind guidance wall 22 to be guided into the wind guidance opening 21, and thereby obtaining an effective cooling of the laser element 8a heated up to high temperature, and achieving an increase of performances or capacities thereof.

### First Embodiment

### <Entire Structures of Optical Disc Drive D>

As is shown in FIGS. 1A and 1B, the optical disc drive D of the first embodiment is construed by comprising the followings, within an inside of a bottom plate cover 1a for building up an outside housing thereof: i.e., a turntable 5 for rotationally driving the disc mounted or loaded when recording/reproducing of information; a disc chuck 6, being attached on the turntable 5 for fixing the disc mounted or loaded on the turntable 5 with an elastic force; a spindle motor 4 for rotationally driving the turntable 5; an optical pickup member 7 being movable in a radial direction of the disc 2 rotated by the turntable for conducting recording/reproducing onto/from the disc; a disc tray 3 for covering a recording surface of the disc 2 on the turntable 5 and an outer periphery surface thereof with a clearance therebetween; a decorative laminated board 10 being disposed on the recording surface of the disc 2 on the turntable 5 with a clearance therefrom and for shielding a radio wave generated from a circuit board, which will be mentioned later; and a mechanical chassis 12 (see FIG. 1B), i.e., a supporting member for supporting the spindle motor 4, the disc tray 3 and the decorative laminated board 10, thereon.

Hereinafter, detailed explanation will be made on the structures of each part of the optical disc drive D.

### <Mechanical Chassis 12>

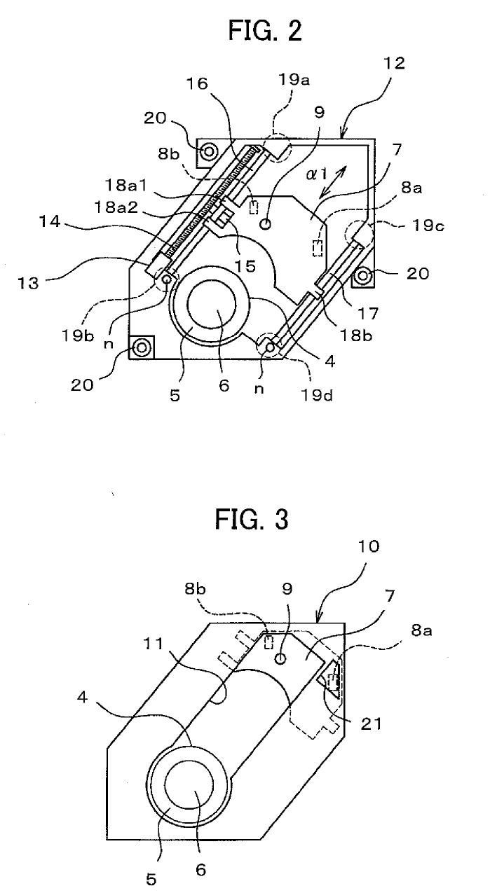

FIG. 2 is a plane view for showing an outline structure of the mechanical chassis 12, under the condition of detaching or removing the disc tray 3 and the decorative laminated board 10 from an inside of the optical disc drive D. However, there is also omitted illustration of a controller board, including the circuit board and FPC (Flexible Print Circuit), etc., therein, for driving and/or controlling the optical disc drive D.

The mechanical chassis 12 shown in FIG. 2 is manufactured by processing bending or drawing upon a thin plate, such as, SS41 (rolled steel for use of general structures), etc., for example, and it supports thereon the optical pickup member 7, the decorative laminated board 10 and the disc tray, which are shown in FIG. 1A, and the circuit board or the like for driving and/or controlling the optical disc drive, respectively.

Further, on the mechanical chassis 12 are mounted the spindle motor 4 for rotating the turntable 5, a stepping motor 13 for reciprocally moving the optical pickup member 7 through rotation of a reed screw 14 shown in FIG. 2, in the radial direction of the disc 2 on the turntable 5 (i.e., direction of an arrow “α1” in FIG. 2), etc.

However, the reed screw 14 is coupled with a rotation shaft of the stepping motor 13, but not shown in the figure, and therefore the reed screw 14 is rotated in a normal/reverse direction through driving the stepping motor 13 into normal/reverse rotation thereof, and accompanying this, the optical pickup member 7 is moved, reciprocally, in the direction of the arrow “α1” in FIG. 2; thus, the radial direction of the disc 2.

Also, as is shown in FIG. 2, to the mechanical chassis 12, the one ends of the guiding shafts of the optical pickup member 7, i.e., a main shaft 16 and an auxiliary shaft 17 are put or inserted into through-holes, which are drilled at coupling portions 19a and 19c of the mechanical chassis 12, respectively (not shown in the figure, but drilled at the coupling portions 19a and 19c extending in the direction perpendicular to the sheet surface of FIG. 2).

On the other hand, the other ends of the main shaft 16 and the auxiliary shaft 17 are put or inserted into through-holes drilled at coupling portions 19b and 19d (not shown in the figure, but drilled at the coupling portions 19b and 19d extending in the direction perpendicular to the sheet surface of FIG. 2), respectively, and are also mounted on helical compression springs (not shown in the figure), which are provided at the coupling portions 19b and 19d, and fixed by screws “n” from above. Further, as the main shaft 16 or the auxiliary shaft 17, a stainless rod, such as, of SUS 303, etc., may be used for example.

Herein, because the main shaft 16 and the auxiliary shaft 17 are fixed at the coupling portions 19b and 19d of the mechanical chassis 12 through the helical compression springs, i.e., due to an elastic function of the spring, compulsive or forced vibration of the mechanical chassis 12 accompanying the rotation of the disc 2 mounted or loaded on the turntable 5 is suppressed to transmit to the optical pickup member 7 mounting the laser element 8a, a laser light receiving element 8b, etc., thereon.

In this manner, since the compulsive or forced vibration is generated on the mechanical chassis 12, accompanying the rotation of the disc 2, when recording/reproducing data, the disc tray 3 is fixed on the mechanical chassis 12 through a vibration proof rubber 20 having viscosity resistance and a vibration attenuation effect.

Further, between the mechanical chassis 12 and the bottom place cover la is normally inserted an under cover, i.e., a thin plate-like member, but this is omitted in the figures attached herewith.

### <Optical Pickup Member 7>

The optical pickup member 7 shown in FIG. 2 has the laser element 8a for oscillating a laser light for conducting the recording/reproducing of data, the laser light receiving element 8b for detecting a reflection light of the laser light from the disc 2, an optical lens 9 for condensing the laser light when recording/reproducing of data, an optical unit (not shown in the figure) including a prism, a mirror, etc., for forming an optical path for the laser light between the disc 2 and the laser element 8a and the laser light receiving element 8b, when recording/reproducing of data, and an optical pickup controller circuit, including an oscillator circuit for the laser element 8a, a circuit for use of the laser light receiving element 8b, a circuit for adjusting a focus distance of the optical lens 9, etc.

The structure for supporting the above-mentioned constituent elements of the optical pickup member 7 may be made from, such as, a zing die cast, a magnesium die cast, an aluminum die cast, etc. However, the zing die cast is preferable to the structure of the optical pickup member 7, because of lightweight thereof, and the zing die cast is suitable for mass production because of the cheap price; therefore, it is the most desirable.

On the optical pickup member 7 is fixed a coupling member 15, such as, a polyacetal nut, etc., spirally coupled with the reed screw 14, so as to move the optical pickup member 7 with rotation of the reed screw 14, in the axial direction thereof.

Also, portions 18a1 and 18a2 on one side-end of the optical pickup member 7 are provided sintered bearings (not shown in the figure), into both of which the main shaft 16 of the guiding shafts is inserted and penetrating through, and also into a portion 18b on the other side-end thereof is inserted the auxiliary shaft 17, to be held between up and down; i.e., the optical pickup member 7 is so constructed that it can be guided along the main shaft 16 and the auxiliary shaft 17.

With such structures, the reed screw 14 is rotated in the normal/reverse direction, through driving the stepping motor 13 into the normal/reserve rotation direction, and accompanying with the normal/reverse rotation of the reed screw 14, the coupling member 15 moves, and along two (2) pieces of the guiding shafts 16 and 17, the optical pickup member 7, to which the coupling member 15 is fixed, is moved, reciprocally, in the direction of the arrow “α1”, i.e., the radial direction of the disc 2.

The laser light oscillated or irradiated from the laser element 8a, which is mounted within the optical pickup member 7, passes through the optical unit not shown in the figure, to be irradiated from the optical lens 9 upon a recording layer of the disc 2, and thereby conducting the recording of data on the disc 2.

On the other hand, when reproducing the data recorded on the disc 2, the reflection light of the laser light oscillated from the laser element 8a, being reflected upon the disc 2, passes from the optical lens 9 through the optical unit, and is received and detected by the laser light receiving element 8b, and thereby conducing the reproducing.

However, the positions for attaching the laser element 8a and the laser light receiving element 8b shown in FIG. 2 are exemplary ones, but the positions for attaching the laser element 8a and the laser light receiving element 8b are different from, for each optical pickup member 7.

For the purpose of promote the heat radiation for the laser element 8a, the attaching position of which differs from for each optical pickup member 7, when the optical pickup member 7 (see FIG. 1A) has moved to the outermost peripheral position of the disc, i.e., when it moves to the position where the laser element 8a shows the maximum value of temperature thereof (the laser element 8a shown by broken lines in FIG. 1A), it is preferable or desired to introduce an airflow generated due to rotation of the disc 2, locally, into the periphery of the laser element 8a at that position.

### <Decorative Laminated Board 10>

Between the optical pickup member 7 shown in FIG. 1A and the disc 2 mounted or loaded on the turntable 5 is provided the decorative laminated board 10, for shielding the electromagnetic waves generated from the circuit board or the like mounted on the mechanical chassis 12, as well as, for stopping or restraining the FPC, which is attached on the optical pickup member 7, from projecting into a side of the disc 2, when the optical pickup member 7 has moved to an inner periphery portion of the disc 2.

FIG. 3 is a plane view for showing the decorative laminated board 10 within the optical disc drive D. However, in this FIG. 3 are shown by solid lines the turntable 5 and the disc chuck 5, which are attached onto the rotation shaft of the spindle motor 4, while showing the optical pickup member 7 moving to the outermost peripheral position of the disc 2 loaded by two-dotted chain lines.

The decorative laminated board 10 shown in FIG. 3 is made from a member having good conductivity and having a predetermined strength, as well as, being formed into such a configuration that it covers the surface side of the mechanical chassis 12 as a whole, so as to shield the circuit board mounted on the mechanical chassis 12, and also to stop the FPC from projection thereof, and it is formed by folding a part of an outer periphery of an aluminum plate, having about 0.3 mm thickness, to the side of the mechanical chassis 12, through drawing process.

The decorative laminated board 10, as is shown in FIG. 3, is drilled with an opening portion 11 at a central portion thereof, having such a configuration that can protrude the turntable 5 and a part of the optical pickup member 7 therefrom.

Also, on the decorative laminated board 10 is drilled the wind guidance opening 21 of about a triangle shape, in an area or region nearly facing to the laser element 8a, when the optical pickup member 7 shown by the two-dotted broken lines in FIG. 3 has moved to the outermost peripheral position of the disc 2 loaded, or in the vicinity thereof.

### <Disc Tray 3>

FIGS. 4A and 4B are views for showing the disc tray 3, wherein FIG. 4A is a plane view for showing a surface side of the disc tray 3 under the condition of detaching or removing the bottom plate cover 1a in FIG. 1A, and FIG. 4B is a plane view for showing a single body of the disc tray 3 from a reverse surface 3a thereof, and FIG. 4C is an enlarged perspective view for showing the vicinity of the wind guidance wall 22, which is formed on the reverse surface 3a of the disc tray 3, seen from a direction “B”.

The disc tray 3 is manufactured through an injection molding of the basic material of ABS (i.e., a copolymer synthetic resin of Acrylonitrile, Butadiene and Styrene) or the like, for example, and is formed into such a configuration that it covers the disc 2 loaded on the turntable 5, but not in contact with the rotating disc 2, with a certain clearance to that. Further, in general, a front surface portion of the disc tray 3 is called “a front bezel” 101.

As is shown in FIG. 4A, with the disc tray 3, on a side of surface 3a, on which the disc 2 is disposed, is formed a short column-like recess portion 3o having a shape for covering the recording surface and the outer periphery of the disc 2 loaded on the turntable 5, having a certain clearance therebetween, so as to prevent it from contacting with the rotating disc 2, and is drilled with an opening 3k for disposing the decorative laminated board 10 thereon, having sizes a little bit larger than the outer configuration of the decorative laminated board 10.

Also, with the disc tray 3, on the reverse surface 3a thereof facing to the optical pickup member 7 moving to the outermost periphery of the disc loaded (see FIG. 4B) is provided the wind guidance wall 22 (see FIGS. 4B and 4C), in a manner like a rib, as shown in FIG. 4A, i.e., contacting with the disc 2 loaded on the outermost periphery thereof through a space, and extending along with a smooth line connecting from an imaginary contact point 2a thereof to an outer periphery of the wind guidance opening 21 of the decorative laminated board 10, in the direction same to the rotation direction of the disc (i.e., the direction of the arrow “α2” in FIG. 4A).

FIG. 5 is an enlarged cross-section view of the wind guidance opening 22 and the decorative laminated board 10 shown in FIG. 4A, being cut along a C-C line.

When recoding and reproducing the data onto/from the disc 2 loaded, since vibration is generated in the mechanical chassis 12 accompanying with rotation of the disc 2, then as is shown in FIG. 5, a gap “s1” is provided between the decorative laminated board 10 and the wind guidance opening 22 of the disc tray 3, so that the decorative laminated board 10 fixed on the mechanical chassis 12 by screws does not contact with the disc tray 3, directly.

FIGS. 6A through 6D are enlarged cross-section views of other examples of the wind guidance opening 22 and the decorative laminated board 10 shown in FIG. 4A, being cut along the C-C line.

The wind guidance wall 22 shown in FIG. 5 is provided standing perpendicular to the reverse surface 3a of the disc tray, but as is shown in FIGS. 6A through 6D, the wind guidance wall 22 may be formed in the configuration inclining to the reverse surface 3a of the disc tray.

### <Reproducing/Recoding Operation of Disc 2>

Next, explanation will be made on the reproducing/recording operation of the disc 2, which is loaded into the optical disc drive D.

Upon loading the disc 2 into the optical disc drive D, if a user pushes down an eject button not shown in the figure, the disc tray 3 is automatically moves on guides (not shown in the figure), which are provided within the drive D, and thereby, as is shown by an arrow “β2” in FIG. 1A, it is taken outside the optical disc drive D.

Following to the above, the user puts the disc 2 on the turntable coupled with the spindle motor 4, and fixes it at a central opening of the disc 2 by the disc chuck 6 exposing from the opening portion 3k of the disc tray 3; thereby loading the disc 2 within the short column-like recess portion 3o of the disc tray 3.

Following to the above, when the user pushes the disc tray 3 mounting the disc 2 thereon into the optical disc drive D, as is shown by the arrow “β2” in FIG. 1A, then the disc tray 3 mounting the disc 2 thereon moves on the guides (not shown in the figure) within the drive D, to be loaded into the optical disc drive D. In this manner, moving of the disc tray 3 on the guides provided within the drive D conducts loading and ejecting of the disc 2 into/from the drive D in the structures.

Following to the above, when the user pushes down a record/reproduce button, the spindle motor 4 is rotationally driven by the driver circuit mounted on the mechanical chassis 12, so that the disc 2 on the turntable 5 rotates into the clockwise direction (direction of the arrow “α2” shown in FIG. 1A or FIG. 4A). Further, the stepping motor 13 (see FIG. 2) is driven/controlled by the driver circuit on the mechanical chassis 12, so that the coupling member 15 spirally coupling to the reed screw 14 is moved by rotation of the reed screw 14 coupled with the stepping motor 13, and accompanying this, the optical pickup member 7 is shifted to move into the radial direction of the disc 2 (direction of the arrow “α1” shown in FIG. 2).

In this manner, the optical pickup member 7 is moved from the inner periphery portion of the disc 2 into the outer peripheral direction thereof, so as to make record on the recording surface of the disc 2, by the laser light from the laser element 8a (see FIG. 1A) through the optical lens 9, thereby achieving the recording of data. Or, alternately, reproducing of data from the recording surface of the disc 2 is conducted by reflecting the laser light from the laser element 8a upon the recording surface of the disc 2 through the optical lens 9, so as to receive it on the laser light receiving element 8b (see FIG. 1A). However, in FIG. 1A, the position of the optical pickup member 7 is shown by the two-dotted broken lines when it lies in middle of the disc 2, but by the solid lines when it is at the outermost periphery portion of the disc 2.

Herein, when conducting multilayer (two (2) layers) recording and reproducing onto/from the disc 2, the optical pickup member 7 is moved from the inner periphery portion to the outer periphery portion of the disc 2 when conducting the recording/reproducing onto/from a first layer, and further it turns back form the outer periphery portion to the inner periphery portion of the disc 2 when conducting the recording/reproducing onto/from a second layer; thereby conducting the recording/reproducing with using the laser element 8a and the laser light receiving element 8b.

In this time, as is shown by the arrow “α1” in FIG. 2, the optical pickup member 7 moves along two (2) pieces of guiding shafts, i.e., the main shaft 16 and the auxiliary shaft 17, which are provided in parallel on the mechanical chassis 12, through the end portions (i.e., the bearing portions) 18a1, 18a2 and 18b on both sides thereof.

### <Functions/Effects>

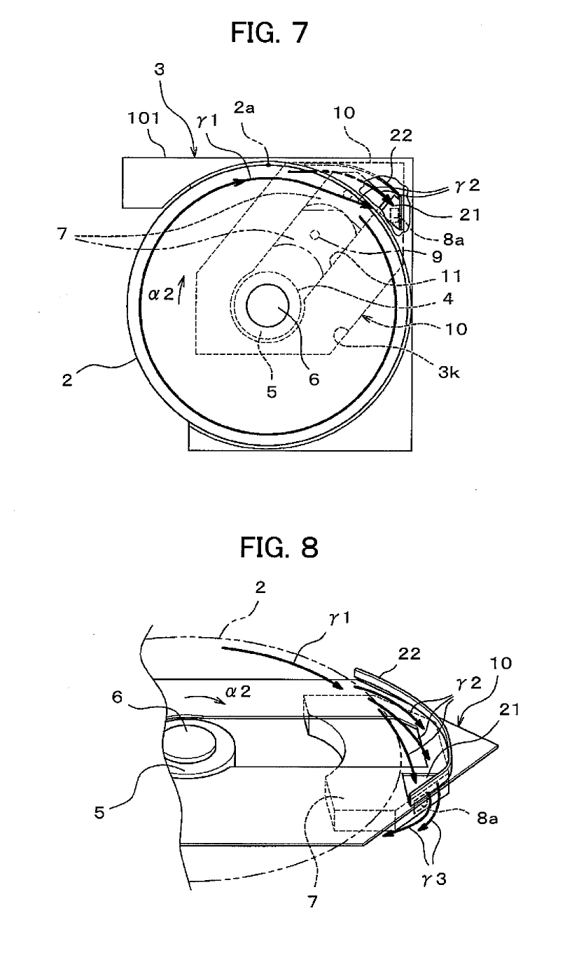

With such structures as was mentioned above, when the optical pickup member 7 has moved to the outermost peripheral position of the disc 2 (i.e., the optical pickup member 7 shown by the solid lines in FIG. 1A), in other words, when it moves to such the position that temperature of the laser element 8a shows the maximum value thereof, it is possible to guide a swirling airflow “γ1” (see FIGS. 7 and 8) flowing along an outer edge of the disc 2, which is produced by rotation of the disc 2 in the clockwise direction (direction of the allow “α2” shown in FIG. 1A or FIG. 4A), into the wind guidance opening 21 mentioned above, along the wind guidance wall 22 provided on the disc tray 3 (i.e., an airflow “γ2” directing the wind guidance opening 21 along the wind guidance wall 22 shown in FIGS. 7 and 8), and further to introduce the airflow, locally, up to the periphery of the laser element 8a of the optical pickup member 7 through the wind guidance opening 21 (see an arrow “γ3” in FIG. 8).

However, those FIGS. 7 and 8 are views for showing outlines of the airflows at this time, by the arrows “γ1”, “γ2” and “γ3”, wherein FIG. 7 is a plane view for showing an outline structure of an inside of the optical disc drive D, for showing the airflow flowing along the wind guidance wall 22 of the disc tray 3 to the wind guidance opening 21 by the arrows “γ1” and “γ2”, and FIG. 8 is a perspective view for showing an outline structure of the inside of the optical disc drive D, for showing the airflow by the arrow “γ3”, flowing into the vicinity of the laser element 8a passing through the wind guidance opening 21 after flowing along the wind guidance wall 22 of the disc tray 3 up to the wind guidance opening 21 (see the arrow “γ2”). However, in FIG. 8, illustration of the disc tray 3 is omitted, for an easy understanding.

As is shown in FIG. 7, after guiding the swirling airflow “γ1” around the outer edge of the disc 2, which is generated by rotation of the disc 2 in the clockwise direction and is relatively high in the flow velocity thereof, along the wind guidance wall 22 of the disc tray 3 up to the wind guidance opening 21 (see the arrow “γ2”), it is possible to lead it to flow into the vicinity of the laser element 8a through the wind guidance opening 21, as is shown in FIG. 8 (see the arrow “γ3”), therefore, it is possible to introduce the swirling airflow “γ1”(see FIGS. 7 and 8) accompanying with rotation of the disc 2 into the vicinity of the laser element 8a of the optical pickup member 7, smoothly.

For this reason, it is possible to increase the flow velocity of the air in the periphery of the laser element 8a of the optical pickup member 7, greatly, and thereby enabling the laser element 8a to radiate the heat generated therefrom, effectively, by means of a convection of air.

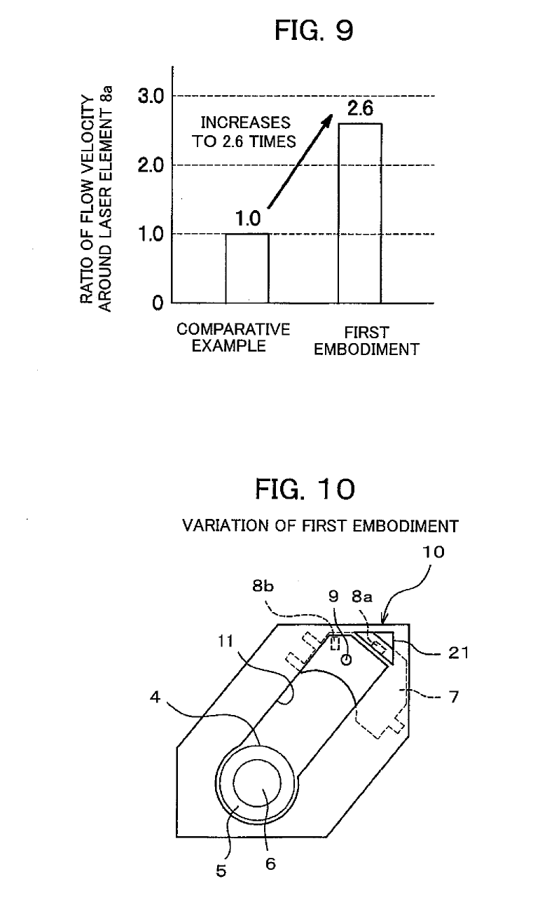

FIG. 9 is a graph for showing an effect of heat radiation promotion according to the first embodiment, wherein a ratio is shown of the flow velocity surrounding the laser element 8a, respectively, for a comparative example and the first embodiment.

The graph in FIG. 9 is obtained by analyzing the flow velocities on the periphery of the laser element 8a when applying the disc 2 with the rotation speed corresponding to a low speed thereof, while measuring a field of flow with an aid of a numeral value flow simulation.

As is shown in FIG. 9, it is apparent that the first embodiment increases the flow velocity up to 2.6 times comparing to that of the comparative example.

### Variation of First Embodiment

FIG. 10 is a plane view for showing the structures of the decorative laminated board 10 of the optical disc drive D, according to a variation of the embodiment 1.

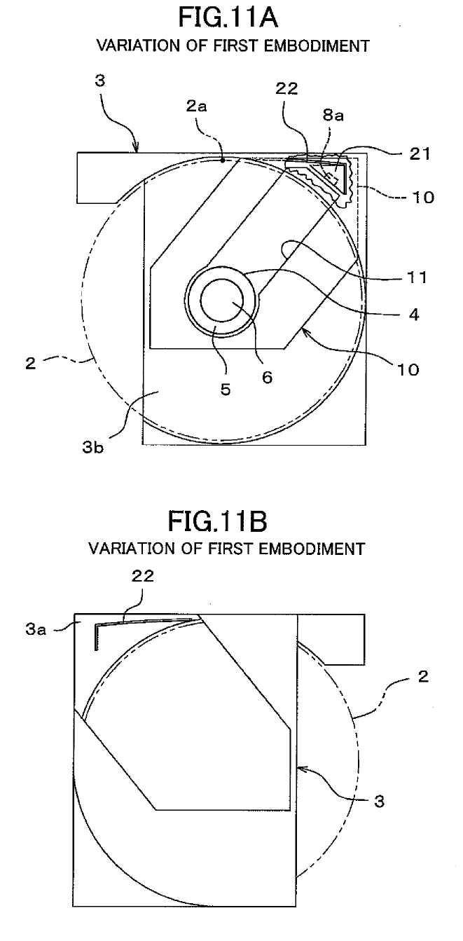

FIG. 11A is a plane view for showing the structures of the disc tray of the optical disc drive D, according to the variation of the embodiment 1, and FIG. 11B is a plane view for showing the reverse surface 3a of a single body of the disc tray 3 of the optical disc drive D, according to the variation of the embodiment 1.

As is shown in FIGS. 10 and 11A and 11B, in case where the position for attaching the laser element 8a of the optical pickup member 7 differs from the position, which was shown in FIG. 2 according to the first embodiment, the position and the configuration of the wind guidance opening 21 drilled on the decorative laminated board 10 must be changed, as is shown in FIG. 10, for example, i.e., depending upon the position of the laser element 8a moving to the outermost peripheral position of the disc, while the wind guidance wall 22 formed on the disc tray 3 must be changed, as is shown in FIGS. 11A and 11B, i.e., depending upon the position of the laser element 8a moving to the outermost peripheral position of the disc 2.

Herein, the configuration of the wind guidance wall 22 may be in a shape like a curved line, as is shown in FIGS. 11A and 11B, or may be like a straight line.

In this manner, with changing the position and the configuration of the wind guidance opening drilled on the decorative laminated board 10, and also changing the position and the configuration of the wind guidance wall 22 formed on the disc tray 3, appropriately, depending on the position for attaching the laser element 8a of the optical pickup member 7, it is possible to obtain the effect of heat radiation promotion, in the similar manner to that in the first embodiment.

### Second Embodiment

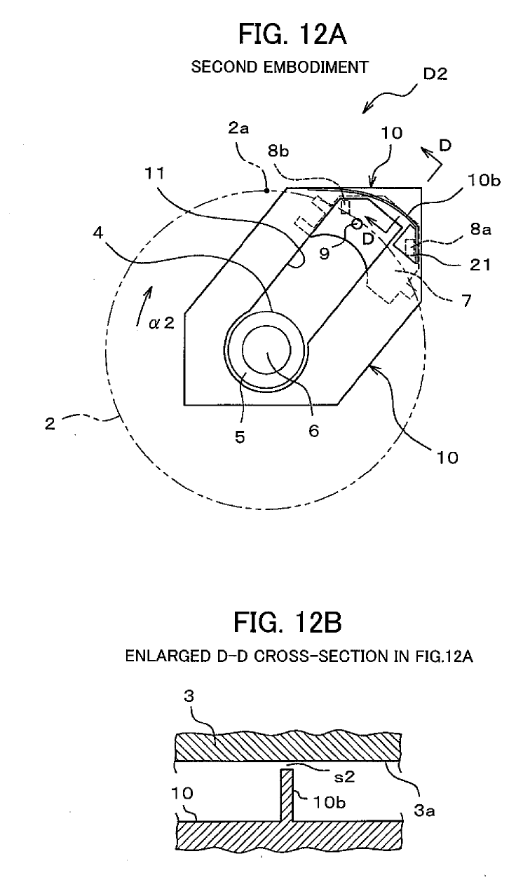

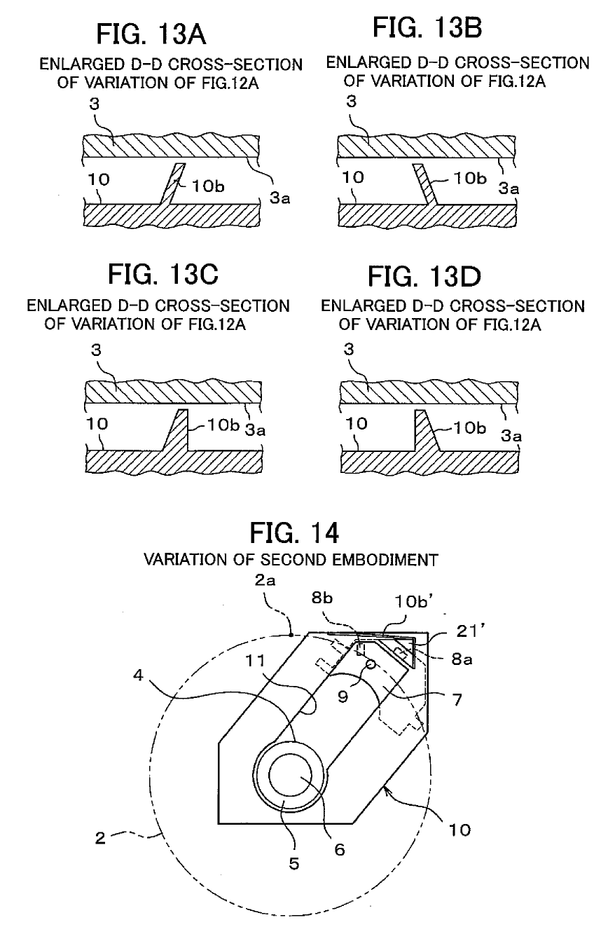

Next, explanation will be given on the optical disc drive D, according to a second embodiment, by referring to FIGS. 12A and 12B, and FIGS. 13A to 13D attached herewith.

However, FIG. 12A is a plane view of the decorative laminated board 10 of the optical disc drive D, according to the second embodiment, and FIG. 12B is an enlarged cross-section view, being cut along D-D line, when adding the disc tray 3 onto the decorative laminated board 10 shown in FIG. 12A.

In the optical disc drive D2, according to the second embodiment, the wind guidance wall 22 formed on the disc tray 3, according to the first embodiment, is provided on the decorative laminated board 10, in the place of the disc tray 3, as a wind guidance wall 10b.

With the structures other than the above, since they are similar to those of the first embodiment, the detailed explanation thereof will be omitted, while attaching the same reference numerals to them.

Within the optical disc drive D2 according to the second embodiment, as is shown in FIG. 12A, the wind guidance opening 21 is provided on the decorative laminated board 10, in an area or region or in the vicinity thereof, almost facing to the laser element 8a of the optical pickup member 7 when the optical pickup member 7 has moved to the outermost peripheral position of the disc (i.e., the optical pickup member 7 shown by the two-dotted broken lines in FIG. 12A).

Also, as is shown in FIG. 12A, the wind guidance wall 10b is provided on the decorative laminated board 10, along with a smooth line contacting with the disc 2 loaded on the turntable 5 on the outermost periphery thereof, and connecting from an imaginary point 2a thereof up to the wind guidance opening 21 provided on the decorative laminated board 10 (see FIG. 12B), extending in the same direction to the rotation direction of the disc 2 (direction of the arrow “α2” shown in FIG. 12A).

When recoding and reproducing the data onto/from the disc 2 loaded, since vibration is generated in the mechanical chassis 12 accompanying with rotation of the disc 2, then as is shown in FIG. 12B, a gap “s2” is provided between the wind guidance wall 10b on the decorative laminated board 10 and the disc tray 3, so that the decorative laminated board 10 fixed on the mechanical chassis 12 in one body by screws does not contact with the disc tray 3, directly.

FIGS. 13A through 13D are enlarged cross-section views of the variation, being cut along D-D line, in case when adding the disc tray 3 onto the decorative laminated board 10 shown in FIG. 12A.

In FIG. 12B is shown an example, in case where the wind guidance wall 10b is provided perpendicular to the decorative laminated board 10, and as is shown in FIGS. 13A through 13D, the wind guidance wall 10b may be provided inclining to the decorative laminated board 10, in the configuration thereof.

With such structures as was mentioned above, when the optical pickup member 7 has moved to the outermost peripheral position of the disc 2 loaded, in other words, when it moves to such the position that temperature of the laser element 8a shows the maximum value thereof,

it is possible to guide a swirling airflow, which is generated along an outer edge of the disc 2, up to the wind guidance opening 21 along the wind guidance wall 10b provided on the decorative laminated board 10, and further to introduce the airflow, locally, up to the periphery of the laser element 8a of the optical pickup member 7 through the wind guidance opening 21.

Since it is possible to introduce the airflow on the outer edge of the disc, relatively high in the flow velocity thereof, smoothly, up to the vicinity of the laser element 8a of the optical pickup member 7, and therefore it is possible to increase the flow velocity of the airflow surrounding the laser element 8a of the optical pickup member 7 and in the vicinity thereof, greatly, thereby enabling the heat generated from the laser element 8a to radiate into the airflow, effectively, by the convection thereof.

### Variation of Second Embodiment

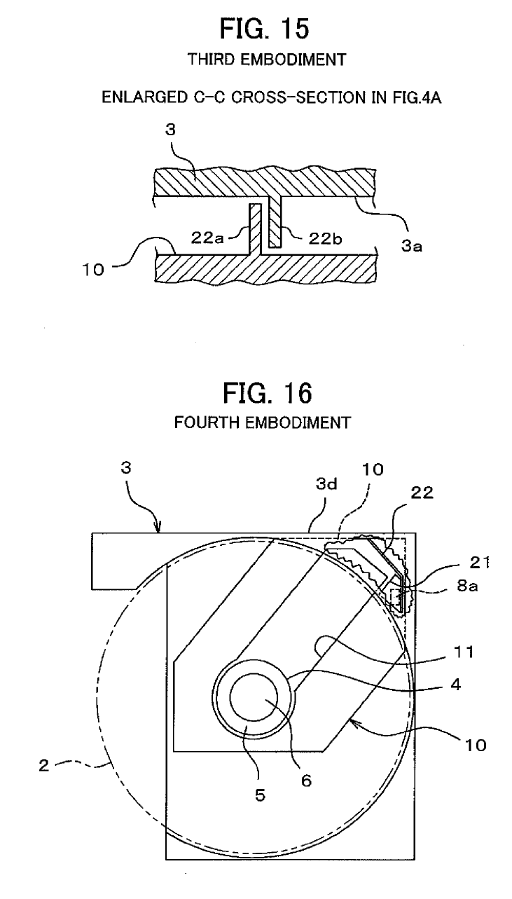

Next, explanation will be given on a variation of the optical disc drive D2 according to the second embodiment, by referring to FIG. 14. However, this FIG. 14 is a plane view of the decorative laminated board 10, in particular, when the position for attaching the laser element 8a is changed in the optical disc drive D according to the second embodiment.

The variation of the second embodiment has the structures for dealing with the case when changing is made on the position for attaching the laser element 8a of the optical pickup member 7.

In the second embodiment, when the position for attaching the laser element 8a differs from that shown in FIGS. 12A and 12B, by changing the positions and the configurations of the wind guidance opening 21′ and the wind guidance wall 10b′, appropriately, depending upon the position of the laser element 8a moving to the outermost peripheral position of the disc 2, it is possible to obtain the promotion effect of heat radiation for the laser element 8a of the optical pickup member 7, in the similar manner to that of the second embodiment.

However, the configuration of the wind guidance wall 10b′ may be in a shape like a curved line, as is shown in FIG. 14, or may be like a straight line.

### Third Embodiment

Next, explanation will be given on a third embodiment, by referring to FIG. 15. However, this FIG. 15 is an enlarged cross-section view, being cut along C-C line shown in FIG. 4A, in the third embodiment.

The third embodiment has such structures that the wind guidance wall, following the wind guidance opening 21 on the decorative laminated board 10, is provided on both the disc tray 3 and the decorative laminated board 10, respectively.

In the third embodiment, as is similar to that shown in FIG. 4A, the wind guidance opening 21 is drilled on the decorative laminated board 10, in the area or region or in the vicinity thereof, almost facing to the laser element 8a of the optical pickup member 7 when the optical pickup member 7 has moved to the outermost peripheral position of the disc 2 loaded.

Also, on the reverse surface 3a of the disc tray 3, i.e., the reverse surface 3a facing to the laser element 8a of the optical pickup member 7 (see FIG. 1A) when it has moved to the outermost periphery portion of the disc 2, and the decorative laminated board 10, as well, as is shown in FIG. 4A, the wind guidance opening 22a is provided on the disc tray 3, as well as, the wind guidance wall 22a is provided on the decorative laminated board 10, as is shown in FIG. 15, contacting on the outer edge of the disc 2 loaded, extending along a smooth line connecting the imaginary contact point 2a thereof up to the wind guidance opening 21 provided on the decorative laminated board 10, as is shown in FIG. 4A, in the same direction to the rotation direction of the disc (direction of the arrow “α2” shown in FIG. 1A and 4A).

The wind guidance walls 22a and 22b shown in FIG. 15 are formed perpendicular to the decorative laminated board 10, respectively, in the example shown therein, but those wind guidance walls 22a and 22b may be formed, in the similar manner to that of the first embodiment and the second embodiment, i.e., inclining to the reverse surface 3a of the disc tray 3 and/or the decorative laminated board 10, respectively (see FIGS. 6A to 6D and FIGS. 13A to 13D).

With such structures as was mentioned above, when the optical pickup member 7 has moved to the outermost peripheral position of the disc 2 loaded on the turntable 5, thus when it moves to such the position that the temperature of the laser element 8a of the optical pickup member 7 shows the maximum value thereof, it is possible to guide the swirling airflow generating along the outer edge of the disc 2 up to the wind guidance opening 21 of the decorative laminated board 10, along the wind guidance walls 22a and 22b, and further to introduce the airflow, locally, to the periphery of the laser element 8a of the optical pickup member 7.

Accordingly, since the airflow on the outer edge of the disc 2, being relatively fast or high in the flow velocity thereof, can be introduced into the vicinity of the laser element 8a, smoothly, therefore it is possible to increase the flow velocity of the airflows surrounding the laser element 8a, greatly, and thereby to enable the heat generated from the laser element 8a to radiate into the airflow, effectively, by the convection thereof.

Also, as is shown in FIG. 15, since the wind guidance wall 22b provided on the decorative laminated board 10 and the wind guidance wall 22a provided on the disc tray 3 are formed, alternately, extending into the direction, into which the decorative laminated board 10 extends, and into the direction, into which the disc tray 3 extends, respectively, therefore the swirling air flow generating with rotation of the disc 2 and flowing into the direction, to which the disc 2 extends (i.e., the horizontal direction on the sheet surface of FIG. 15), is blocked out by the wind guidance wall 22b of the decorative laminated board 10 and the wind guidance wall 22a of the disc tray 3, and thereby enabling to guide the wind into the wind guidance opening 21 of the decorative laminated board 10, with high efficiency. For this reason, it is possible to obtain the cooling of the laser element 8a of the optical pickup member 7, effectively.

### Fourth Embodiment

Next, explanation will be given on a fourth embodiment, by referring to FIG. 16. However, this FIG. 16 is a plane view of the surrounding or vicinity of the disc tray 3, according to the fourth embodiment, including a cutoff portion thereof.

As is shown in FIG. 16, in the fourth embodiment, the wind guidance opening 21 is provided on the decorative laminated board 10, in the area or region thereof almost facing to the laser element 8a of the optical pickup member 7 when the topical pickup member 7 has moved to the outermost peripheral position of the disc 2 through the coupling member 15, accompanying with rotation of the reed screw 14 (see FIG. 2), and also the wind guidance wall 22 is provided on the reverse surface 3a of the disc tray 3 facing to the optical pickup member 7 moving to the outermost periphery portion of the disc 2, extending from an outer vertical wall 3d of the disc tray 3 (formed in the vertical direction on the sheet surface of FIG. 16) or the vicinity thereof up to the wind guidance opening 21 of the decorative laminated board 10.

With such structures as was mentioned above, when the optical pickup member 7 has moved to the outermost peripheral position of the disc 2, thus when it moves to such position that the temperature of the laser element 8a of the optical pickup member 7 shows the maximum value thereof, it is possible to guide the swirling airflow, generating with the rotation of the disc 2, into the wind guidance opening 21 along with the outer vertical wall 3d of the disc tray 3 and the wind guidance wall 22, and further to introduce the airflow, locally, into the surrounding or periphery of the laser element 8a of the optical pickup member 7 through the wind guidance opening 21.

However, as shown in FIGS. 16 and 5,the wind guidance wall 22 may be formed to stand perpendicular to the reverse surface 3a of the disc tray, or may be inclined. Or, the configuration of the wind guidance wall 22 may be a straight-line like, or may be a curved-line like, as is shown in FIG. 16.

### Fifth Embodiment

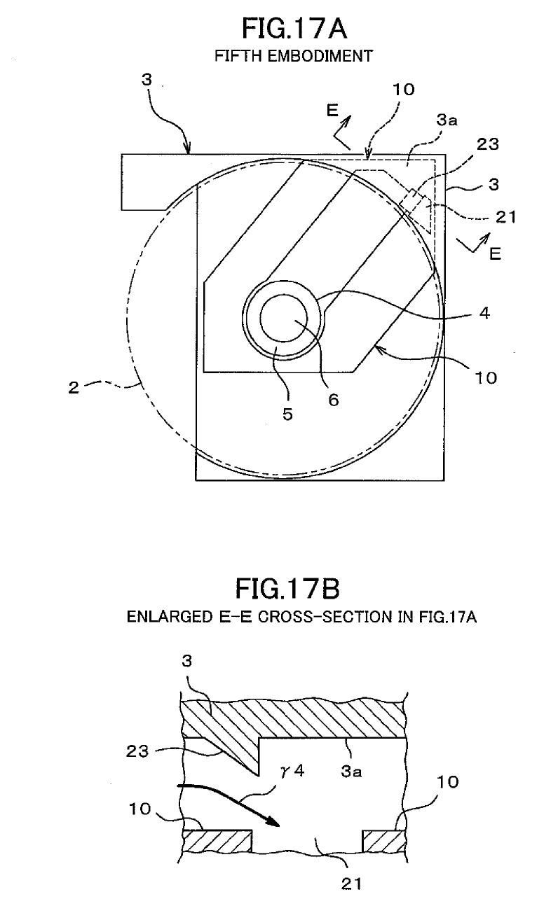

Next, explanation will be given on a fifth embodiment, by referring to FIGS. 17A and 17B. However, FIG. 17A is a plane view of the surrounding or the vicinity of the disc tray 3, according to the fifth embodiment, and FIG. 17B is an enlarged cross-section view of the disc tray shown in FIG. 17A, being cut along E-E line, while showing an airflow flowing into the wind guidance opening 21 by an arrow “γ4” therein.

As is shown in FIGS. 17A and 17B, in the structures according to the fifth embodiment, there is provided a projection portion 23 having such an inclination that it approaches to the wind guidance opening 21 into the rotation direction of the disc 2, obliquely, in the direction almost same to the direction of the airflow from the reverse surface 3a of the disc tray, at a position corresponding to an upstream of the airflow due to the rotation of the disc 2. However, in FIG. 17B is omitted the illustration of the wind guidance wall 22.

With such structures as was mentioned above, when the optical pickup member 7 has moved to the outermost peripheral position of the disc 2, thus when it moves to such position that the temperature of the laser element 8a of the optical pickup member 7 shows the maximum value thereof, it is possible to guide the airflow generating with the rotation of the disc 2, into the wind guidance opening 21 along with the wind guidance wall 22, and further to guide the airflow by the projection portion 23 provided on the reserve surface 3a of the disc tray, thereby to introduce that airflow, effectively, into the surrounding or periphery of the laser element 8a of the optical pickup member 7 through the wind guidance opening 21, as is shown by the arrow “γ4” in FIG. 17B.

### Other Variation(s)

As was mentioned above, in the first to the fifth embodiments, the gap “s1” is provided between the wind guidance wall 22 of the disc tray 3 and the decorative laminated board 10, as is shown in FIG. 12B, for not transmitting the compulsive or forced vibration, generating in the mechanical chassis 12 due to rotation of the disc 2, to the disc tray 3, and also the gap “s2” is provided between the wind guidance wall 10b of the decorative laminated board 10 and the disc tray 3, as is shown in FIG. 12B.

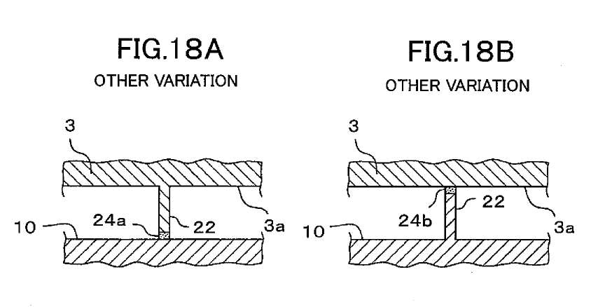

FIG. 18A is a cross-section view for showing the structures of putting or sandwiching the sponge-like member 24a between the wind guidance wall 22 provided on the disc tray 3 and the decorative laminated board 10, and FIG. 18B is a cross-section view for showing the structures of sandwiching the sponge-like member 24b between the wind guidance opening 22 provided on the decorative laminated board 10 and the disc tray 3.

As is shown in FIG. 18A may be sandwiched the sponge-like member 24a for absorbing the vibration, between the wind guidance wall 22 provided on the disc tray 3 and the decorative laminated board 10, or as is shown in FIG. 18B, the sponge-like member 24b for absorbing the vibration may be sandwiched between the wind guidance opening 22 of the decorative laminated board 10 and the disc tray 3.

In this manner, with provision of the sponge-like member 24a between the wind guidance wall 22 and the decorative laminated board 10, or with provision of the sponge-like member 24b between the between the wind guidance wall 22 and the disc tray 3, the compulsive or forced vibration can be attenuated by the sponge-like member(s) 24a and/or 24b.

Also, since the airflow generating with rotation of the disc 2 is blocked or prevented, as is shown in FIG. 18A, by the sponge-like member 24a, from leaking from the gap defined between the wind guidance wall 22 and the decorative laminated board 10, and also as is shown in FIG. 18B, since it is blocked or prevented by the sponge-like member 24a, from leaking from the gap defined between the wind guidance wall 22 and the disc tray 3, therefore it is possible to introduce the airflow of much larger amount into the vicinity of the laser element 8a of the optical pickup member 7, and thereby increasing the cooling effect of the laser element 8a.

As was mentioned above, the wind guidance wall(s), which is provided on the disc tray 3 or the decorative laminated board 10, or are provided on both of them, is/are provided, extending from the wind guidance opening 21 of the decorative laminated board 10 or the vicinity thereof into a reversed rotation direct of the disc 2, and therefore, the functions/effects mentioned above can be obtained.

### Conclusion

According to the optical disc drive according to the present invention, since the airflow on the outer edge of the disc, having a relatively high or fast flow velocity thereof, can be introduced, smoothly, into the surrounding or the periphery of the laser element of the optical head member, therefore it is possible to radiate the heat generated from the laser element, effectively. With this, it is possible to restrain the laser element from deterioration of lifetime thereof, by suppressing the increase of temperature of the laser element, and thereby enabling to achieve an increase of performances or capacities of the optical disc drive.

However, the structures applied within the first to the fifth embodiments are able to achieve the promotion effect of heat radiation, also when recording and reproducing the disc 2, but other than the multiplayer recording mentioned above.

Also, in the first to the fifth embodiments mentioned above, the explanation was given on the example of the notebook-type personal computer, as the electronic apparatus applying the optical disc drive therein, for example, however as other electronic apparatuses than the notebook-type personal computer, into which the optical disc drive according to the present invention can be applied, may be the followings: an on-vehicle computer, such as, a car navigation system or the like, a camera loading an optical disc therein, a game machine, etc., for example, i.e., not restricted but applicable, widely, as far as it is an electronic apparatus loading the optical disc therein.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disc drive, comprising:
a disc tray member, which is configured to be used for loading/ejecting of a disc as information recording medium;
an optical pickup member, which has a laser element for oscillating a laser light therefrom, to be irradiated on said disc;
a disc rotating mechanism, which is configured to rotate said disc;
a transferring mechanism, which is configured to move said optical pickup member between an inner periphery portion and an outer periphery portion of said disc; and
a decorative laminated board, which is provided between said disc loaded and a controller portion mounted, wherein
said decorative laminated board has a wind guidance opening, for guiding an air into an area facing to the laser element of said optical pickup member when said optical pickup member has moved to the outermost periphery portion of said disc to be rotated, and
said disc tray member has a wind guidance wall portion on a surface thereof, facing to said optical pickup member having moved to an outermost periphery portion of said disc, extending from said wind guidance opening or vicinity thereof into a reversed rotation direction of said disc.

2. The optical disc drive, as described in the claim 1, wherein
on a surface of said disc tray facing to said optical pickup member having moved to the outermost periphery portion of said disc is provided a projection portion, having such an inclination that it approaches to said wind guidance opening in a rotation direction of said disc as it advances in the rotation direction of said disc.

3. The optical disc drive, as described in the claim 1, wherein
said wind guidance wall portion is so formed that it continues up to said wind guidance opening along an outer edge of said disc.

4. An optical disc drive, comprising:
a disc tray member, which is configured to be used for loading/ejecting of a disc as information recording medium;
an optical pickup member, which has a laser element for oscillating a laser light therefrom, to be irradiated on said disc;
a disc rotating mechanism, which is configured to rotate said disc;
a transferring mechanism, which is configured to move said optical pickup member between an inner periphery portion and an outer periphery portion of said disc; and
a decorative laminated board, which is provided between said disc loaded and a controller portion mounted, wherein
said decorative laminated board has a wind guidance opening, for guiding an air into an area facing to the laser element of said optical pickup member when said optical pickup member has moved to the outermost periphery portion of said disc to be rotated, and a wind guidance wall potion facing to said optical pickup member having moved to the outermost periphery portion of said disc, extending from said wind guidance opening or vicinity thereof into a reversed rotation direction of said disc.

5. The optical disc drive, as described in the claim 4, wherein
on a surface of said disc tray facing to said optical pickup member having moved to the outermost periphery portion of said disc is provided a projection portion, having such an inclination that it approaches to said wind guidance opening in a rotation direction of said disc as it advances in the rotation direction of said disc.

6. The optical disc drive, as described in the claim 4, wherein
said wind guidance wall portion is so formed that it continues up to said wind guidance opening along an outer edge of said disc.

7. An optical disc drive, comprising:
a disc tray member, which is configured to be used for loading/ejecting of a disc as information recording medium;
an optical pickup member, which has a laser element for oscillating a laser light therefrom, to be irradiated on said disc;
a disc rotating mechanism, which is configured to rotate said disc;
a transferring mechanism, which is configured to move said optical pickup member between an inner periphery portion and an outer periphery portion of said disc; and
a decorative laminated board, which is provided between said disc loaded and a controller portion mounted, wherein
a wind guidance opening is provide for driving an air into an area of said decorative laminated board, facing to the laser element of said optical pickup member having moved to the outermost periphery portion of said disc, and
on a surface of disc tray portion facing to said optical pickup member having moved to the outermost periphery portion of said disc and said decorative laminated board are provided wind guidance wall portions, respectively, extending from said wind guidance opening or vicinity thereof into a reversed rotation direction of said disc.

8. The optical disc drive, as described in the claim 7, wherein
on a surface of said disc tray facing to said optical pickup member having moved to the outermost periphery portion of said disc is provided a projection portion, having such an inclination that it approaches to said wind guidance opening in a rotation direction of said disc as it advances in the rotation direction of said disc.

9. The optical disc drive, as described in the claim 7, wherein
said wind guidance wall portion is so formed that it continues up to said wind guidance opening along an outer edge of said disc.

10. An electronic apparatus, having the optical disc as described in the claim 1.

11. An electronic apparatus, having the optical disc as described in the claim 4.

12. An electronic apparatus, having the optical disc as described in the claim 7.
